(19) United States
(12) Patent Application Publication
(10) Pub. No.: US 2002/0034190 A1
(43) Pub. Date: Mar. 21, 2002

(54) System that uses Idle cellular resources for voice and data services

(75) Inventors: Yaron Baratz, Herzlia (IL); Noah Itzhak, Moshav Neve Mivtach (IL)

Correspondence Address: DR. MARK FRIEDMAN LTD., c/o ANTHONY CASTORINA, SUITE 207, 2001JEFFERSON DAVIS HIGHWAY, ARLINGTON, VA, 22202, US

(73) Assignee: SEPTIER COMMUNICATION LTD.

(21) Appl. No.: 09/789,626

(22) Filed: Feb. 22, 2001

Related U.S. Application Data
(60) Provisional application No. 60/183,780, filed on Feb. 22, 2000.

(51) Int. Cl. H04M 11/00

(52) U.S. Cl. 370/450; 455/405

(57) ABSTRACT

A method and associated hardware for managing communications in a cellular network. Network usage is monitored by signaling mediation probes, either by monitoring signaling links or by receiving usage information from network elements. Based on the monitored network usage, an activity server predicts a forthcoming time interval during which sufficient network resources will be available to allow a predetermined message to be sent to one or more users of the network. When the time interval arrives, the activity server initiates the sending of the message, either by itself sending the message or by triggering another device to send the message.

### FIELD AND BACKGROUND OF THE INVENTION

The present invention relates to cellular communications and, more particularly, to a method and improved cellular communications network in which messages to users are sent to the users only when sufficient network resources are available for that purpose.

FIG. 1 is a simplified diagram of a voice and data cellular communications network 100 according to the GSM standard. Network 100 facilitates voice and data communication among a plurality of Mobile Stations 10, voice communication between Mobile Stations 10 and a Public Switched Telephone Network 26, and data communication between Mobile Stations 10 and a Public Switched Packet Network 28. Mobile Stations 10 that are physically located within a cell associated with a Base Transceiver Station 12 communicate wirelessly, via RF channels 30, with that Base Transceiver Station 12. Base Transceiver Stations 12 are controlled by a Base Station Controller 14. Base Station Controller 14 is interfaced to Public Switched Telephone Network 26 via a Mobile Switching Center 18 and a Gateway Mobile Switching Center 16. Base Station Controller 14 is interfaced to Public Switched Packet Network 28 via a Serving GPRS Support Node 20 and a Gateway GPRS Support Node 22. Gateway Mobile Switching Center 16, Mobile Switching Center 18, Serving GPRS Support Node 20 and gateway GPRS Support Node 24 communicate with a Home Location Register 24 for accounting purposes.

Base Transceiver Stations 12, Base Station Controller 14, Gateway Mobile Switching Center 16, Mobile Switching Center 18, Serving GPRS Support Node 20, Gateway GPRS Support Node 22 and Home Location Register 24 are network elements of network 100, and are examples are network elements of cellular communication networks generally. Note that the terms “network element” and “network component” are used interchangeably herein. The network elements of network 100 are interconnected by signaling links, some of which are labeled in FIG. 1 by the corresponding protocols: A-bis for the signaling links connecting Base Transceiver Stations 12 to Base Station Controller 14, A for the signaling link connecting Base Station Controller 14 to Mobile Switching Center 18, Gb for the signaling link connecting Base Station Controller 14 to Serving GPRS support Node 20, MAP for the signaling links connecting Mobile Switching Center 18 and Serving GPRS Support Node 20 to Home Location Register 24. Gn for the signaling link connecting Serving GPRS Support Node 20 to Gateway GPRS Support Node 22, and Gi for the signaling link connecting Gateway GPRS Support Node 22 to Home Location Register 24.

A network such as network 100 is designed to accommodate the largest service demand that is typically expected. As a result, expensive resources of network 100, such as many of RF channels 30, often are idle. Therefore, there is a widely recognized need for, and it would be highly advantageous to have, a way to monitor the availability of idle resources in a network such as network 100 and to use these resources for additional services.

Acronyms

The following acronyms are used extensively in the Annex:

AuC authentication center

BSC base station controller

BSS base station system

BTS base transceiver station

CS circuit switched

EIR equipment identity register

GGSN gateway GPRS support node

GMSC gateway MSC

GPRS general packet radio service

GSM global system for mobile communications

GSN GPRS support node

HLR home location register

IMEI international mobile equipment identity

IMSI international mobile subscriber identity

LA location area

LMSI local mobile station identity

MAP mobile application part (a protocol)

ME mobile equipment

MS mobile station

MSC mobile switching center

MSISDN mobile station internal ISDN number

MSRN mobile station roaming number

MT mobile termination

PDP packet data protocol

PLMN public land mobile network

PS packet switched

PSPN public switched packet network

PSTN public switched telephone network

PTP point to point

RA routing area

RPOA recognized private operating agency

RR radio resource

SGSN serving GPRS support node

SIM subscriber identity module

TA terminal adapter

TE terminal equipment

TMSI temporary mobile station identity

VLR visitor location register

### SUMMARY OF THE INVENTION

It is an object of the present invention to achieve better use of the network capacity of a cellular network and to enable new services based on resource availability of the cellular network by considering the resource availability of network components in controlling applications and services that can be scheduled to times when such resources are available. The present invention is applicable, inter alia, to GSM networks, GPRS networks, IS95-B networks and HSCSD networks.

According to the present invention there is provided, in a communication network wherein a plurality of users communicate via a plurality of network elements connected by signaling links, a method of controlling communication with a user, including the steps of: (a) identifying a forthcoming time interval wherein sufficient network elements will be available for sending a message to the user; and (b) initiating a sending of the message to the user during the time interval via the available network elements.

According to the present invention there is provided an improved communication network wherein a plurality of users communicate via a plurality of network elements connected by a plurality of signaling links, the improvement including: (a) at least one signaling mediation probe for monitoring usage of the network; and (b) an availability server for predicting, based on the monitored usage, a forthcoming time interval wherein sufficient network elements will be available for sending a message to one of the users.

The present invention adds, to a network such as network 100, two new types of hardware: one or more signaling mediation probe and an availability server. The mediation probes monitor network usage, either by monitoring usage of one or more of the signal links, or by receiving usage information from one or more of the network elements, or by both monitoring usage of one or more of the signal links and receiving usage information from one or more of the network elements. Based on this monitoring, the availability server predicts a forthcoming time interval during which sufficient network elements will be available to send a predetermined message to one or more users. When that time interval arrives, the availability server initiates the sending of the message. “Initiating” the sending of the message includes at least eh following possibilities: either the availability server itself sends the message to the user or users, or the availability server triggers the sending of the message to the user or the users by a different device.

Preferably, a signaling mediation probe, that monitors signal link usage, monitors SS7 signaling traffic on the monitored signal link.

Preferably, a signaling mediation probe, that receives usage information from a network element, receives this information from a Mobile Switching Center, from a Serving GPRS Support Node, from a Gateway GPRS Support Node, from a Home Location Register or from a Visitor Location Register.

Preferably, the prediction of the forthcoming time interval is effected by first order averaging, by a phase locked loop, by fuzzy logic or by a neural network.

Preferably, the signaling mediation probes monitor network usage on a per user basis. The availability server determines respective user profiles from the users' network usage. The availability server then selects the user or users for whom the message is appropriate, and targets the message to that user or to those users. Optionally, the availability server bills the users according to the users' respective network usage.

Optionally, the message is sent to a user in response to a request by that user,

Preferably, the message is an SMS message, a WAP message, e-mail, push advertising, streaming video or a voice message.

### BRIEF DESCRIPTION OF THE DRAWINGS

The invention is herein described, by way of example only, with reference to the accompanying drawings, wherein:

FIG. 1 is a simplified diagram of a prior art voice and data communication network;

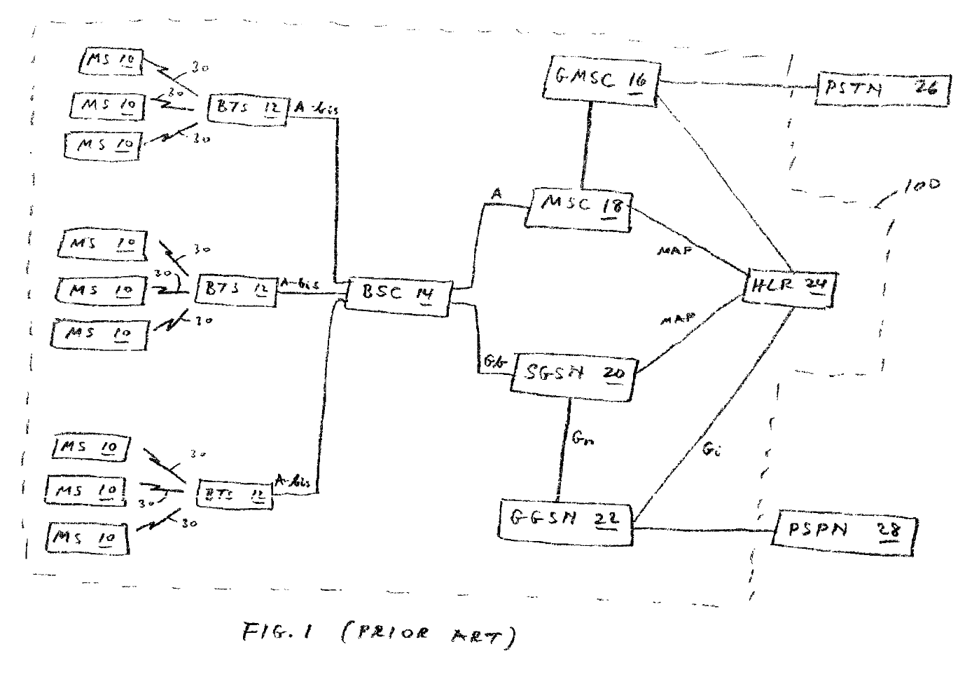

FIG. 2 shows the network of FIG. 1 enhanced according to the present invention, using overlay topology;

FIG. 3 shows the network of FIG. 1 enhanced according to the present invention, using network active topology.

### DESCRIPTION OF THE PREFERRED EMBODIMENTS

The present invention is of a method, and associated hardware, for managing communication in a network such as a cellular telephony network. Specifically, the present invention can be used to send messages to the users of the network as network resources become available.

The principles and operation of network communication management according to the present invention may be better understood with reference to the drawings and the accompanying description.

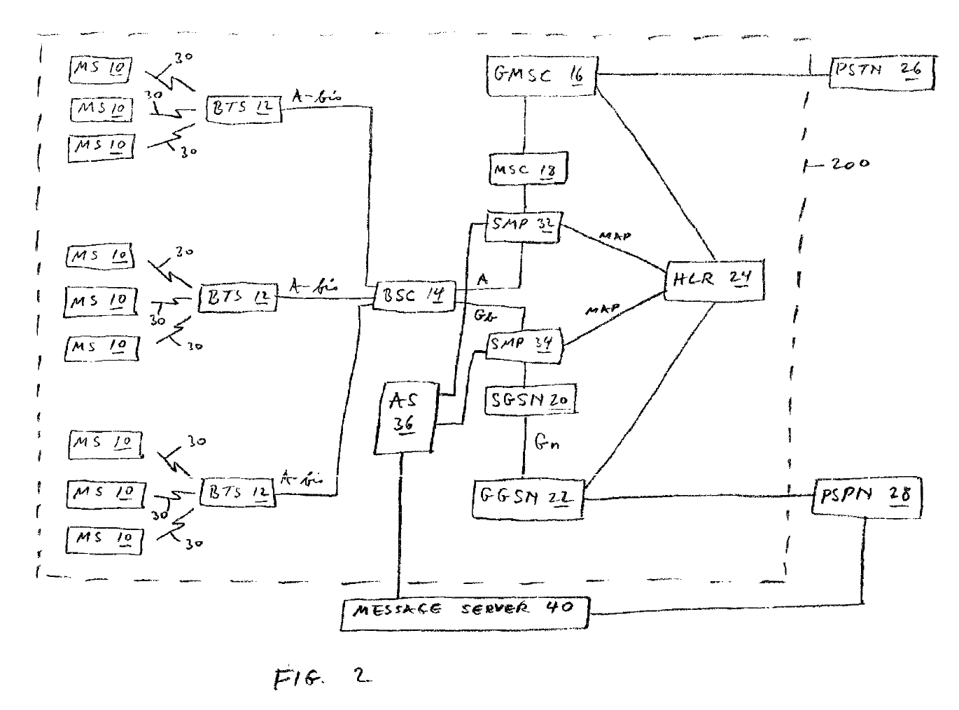

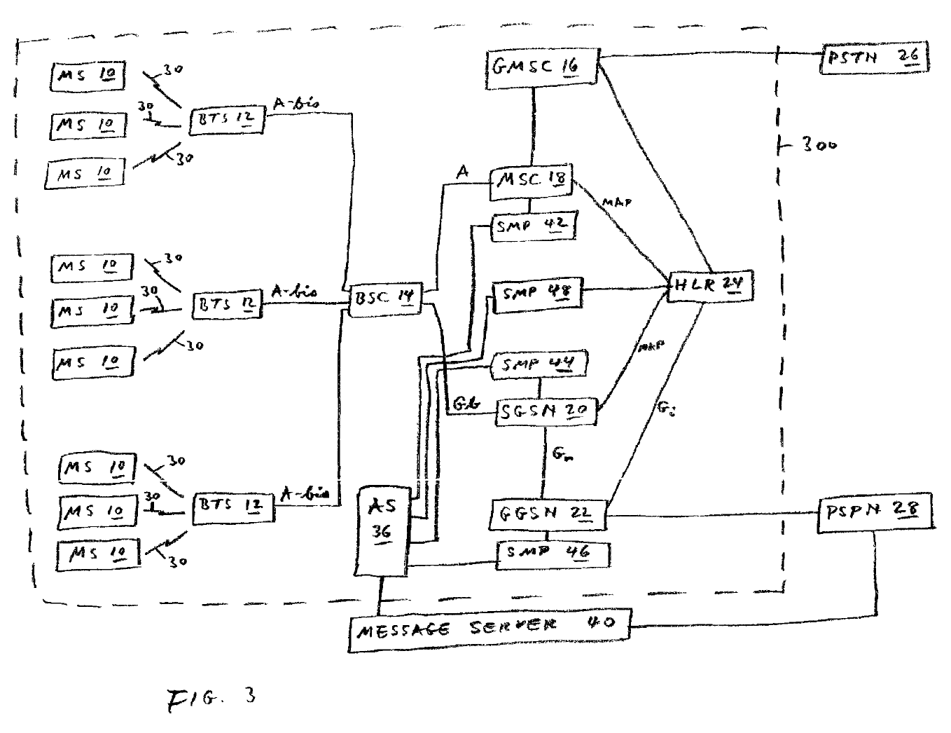

Returning now to the drawings, FIG. 2 and 3 show network 100 enhanced according to the principles of the present invention. FIG. 2 shows an overlay topology network 200 of the present invention. FIG. 3 shows an active topology network 300 of the present invention.

In network 200, two new types of hardware have been added to network 100: two Signaling Mediation Probes 32 and 34 and an Availability Server 36. Signaling Mediation Probe 32 monitors SS5 network traffic on the signaling link between Base Station Controller 14 and Mobile Switching Center 18. Signaling Mediation Probe 34 monitors SS7 network traffic on the signaling link between Base Station Controller 14 and Serving GPRS Support Node 20. Availability Server 36 receives information from Signaling Mediation Probes 32 and 34 regarding the availability of the resources of network 200 and predicts a forthcoming time interval when sufficient resources will be available to support the sending of messages to targeted users of Mobile Stations 10. Many techniques for performing this prediction are known in the art and need not be recited here. Among these techniques are first order averaging, phase locked loop, fuzzy logic and neural network. See, for example, references 9-11 of the Annex: Bor-Sen Chen and Sen-Chueh Peng, “Traffic modeling, prediction and congestion control for high-speed networks: a fuzzy AR approach”, IEEE Trans. Fuzzy Systems vol. 8 no. 5 (October 2000): A. Kolarov et al., “Applications of Kalman filter in high-speed networks”, IEEE Global Telecommunications Conference vol. 1 pp. 624-628 (1994); and Joaquin E. Neves et al., “Adpative technique for ATM call admission and routing control using traffic prediction by neural networks”, IEEE Symposium on Computers and Communications—Proceedings pp. 54-61 (1997).

When the predicted time interval arrives, Availability Server 36 initiates the sending of the message to Mobile Stations 10 of the targeted users. If the message is stored at Availability Server 36, then Availability Server 36 itself sends the message, for example via Public Switched Telephone Network 26 if the message is a voice message, or via Public Switched Packet Network 28 if the message is a data message. FIG. 2 illustrates al alternate option, in which the message is stored in a message server 40 that is external to network 200. Under this option, Availability Server 36 triggers the sending of the message (in this case a data message) by message server 40 via Public Switched Packet Network 28.

In network 300, four Signaling Mediation Probes 42, 44, 46 and 48 are associated with respective network elements: Signaling Mediation Probe 42 is associated with Mobile Switching Center 18. Signaling Mediation Probe 44 is associated with Serving GPRS Support Node 20, Signaling Mediation Probe 46 is associated with Gateway GPRS Support Node 22 and Signaling Mediation Probe 48 is associated with Home Location Register 24. Rather than monitoring SS7 network traffic, Signaling Mediation Probes 42, 44, 46 and 48 receive usage information from their respective network elements. The Annex presents scenarios, under the GSM standard, that show that the usage information needed to predict the forthcoming time interval is in fact available from network elements such as Serving GPRS Support Node 20. In all other respects, network 300 operates the same as network 200.

The present invention is applicable to the sending of a wide variety of messages to users of Mobile Stations 10. Some types of messages are directed at all Mobile Stations 10 that are within range of Base Transceiver Stations 12. For example, in a heavily congested circuit switched network 200 or 300, in which all traffic channels often are in use so that some Mobile Stations 10 repeatedly receive busy signals when trying to request the allocation of a traffic channel, Availability Server 36 sends a message such as an SMS message to all Mobile Stations via a signaling channel, indicating how soon some traffic channels are likely to be available.

Other types of messages are directed at specifically targeted users of Mobile Stations 10. For example, the delivery of e-mail from Public Switched Packet Network 28 to a specific addressee is delayed until sufficient network resources are available to support the delivery of the e-mail to the addressee. Optionally, Signaling Mediation Probes 32 and 34, or 42, 44 and 46 monitor network usage on a per user basis, including, for example, monitoring the destinations to which the user sends data messages. For each monitored user, Availability Server 40 constructs a user profile and advises advertisers, via Public Switched Packet Network 28, which users may be interested in their products. The advertisers prepare corresponding push advertising messages that are delivered to targeted users by Availability Server 40 as network resources that support the delivers become available. Optionally, Availability Server 40 also uses the per-user information to bill the users individually for their use of network 200 or 300.

Some message deliveries are initiated by users. For example, a user wanting to receive streaming video notifies Availability Server 40 to download the streaming video from a World Wide Web site, via Public Switched packet network 28, when sufficient network resources become available for that application.

The Annex includes a simulation of the present invention that shows that the present invention improves the utilization of a communications network such as network 100 with negligible impact on the throughput of individual connections.

While the invention has been described with respect to a limited number of embodiments, it will be appreciated that many variations, modifications and other applications of the invention may be made.

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. In a communication network wherein a plurality of users communicate via a plurality of network elements connected by signaling links, a method of controlling communication with a user, comprising the steps of:
(a) identifying a forthcoming time interval wherein sufficient network elements will be available for sending a message to the user; and
(b) initiating a sending of said message to the user during said time interval via said available network elements.

2. The method of claim 1, wherein said identifying is effected by steps including:
(i) monitoring usage of at least one of the signaling links; and
(ii) based on said usage, predicting said forthcoming time interval.

3. The method of claim 2, wherein said at least one signaling link is an SS7 signaling link.

4. The method of claim 2, wherein said predicting is effected using a technique selected from the group consisting of first order average, phase locked loop, fuzzy logic and neural networks.

5. The method of claim 1, wherein said identifying is effected by steps including:
(i) receiving usage information from at least one of the network elements; and
(ii) based on said information, predicting said forthcoming time interval.

6. The method of claim 5, wherein said at least one network element is selected from the group consisting of Mobile Switching Centers, Serving GPRS Support Nodes, Gateway GPRS Support Nodes, Home Location Registers and Visitor Location Registers.

7. The method of claim 5, wherein said predicting is effected using a method selected from the group consisting of first order average, phase locked loop, fuzzy logic, and neural network.

8. The method of claim 1, furhter comprising the step of:
(c) based on said information, billing at least one of the users.

9. The method of claim 1, wherein said message is sent in response to a request by the user.

10. The method of claim 1, furhter comprising the step of:
(c) selecting one of the users for which said message is appropriate;
said message then being sent to said selected user.

11. The method of claim 10, wherein said selecting includes the steps of:
(i) monitoring communications of the users; and
(ii) based on said monitoring, determining respective profiles of the users.

12. The method of claim 1, wherein said message is selected from the group consisting of SMS messages, WAP messages, e-mail, push advertising, streaming video and voice messages.

13. An improved communication network wherein a plurality of users communicate via a plurality of network elements connected by a plurality of signaling links, the improvement comprising:
(a) at least one signaling mediation probe for monitoring usage of the network; and
(b) an availability server for predicting, based on said monitored usage, a forthcoming time interval wherein sufficient network elements will be available for sending a message to one of the users.

14. The network of claim 13, wherein said availability server is further operative to initiate a sending of said message to said one user during said time interval via said available network elements.

15. The network of claim 13, wherein at least one of said at least one signaling mediation probe monitors usage of at least one of the signaling links.

16. The network of claim 15, wherein said at least one signaling link is an SS7 signaling link.

17. The network of claim 1, wherein at least one of said at least one signaling mediation probe monitors usage of at least one of the network elements.

18. The network of claim 17, wherein said at least one network element is selected from the group consisting of Mobile Switching Centers, Serving GPRS Support Nodes, Gateway GPRS Support Nodes, Home Location Registers and Visitor Location Registers.

19. The network of claim 13, wherein said predicting is effected using a technique selected from the group consisting of first order average, phase locked loop, fuzzy logic and neural networks.

20. The network of claim 13, wherein said at least one signaling mediation probe is operative to monitor said usage on a per user basis, and wherein said availability server is operative to determine respective profiles of the users based on said per user monitoring.

21. The network of claim 20, wherein said availability server is furhter operative to select said one user for whom said message is appropriate, based on said profiles, and to initiate a sending of said message to said one user during said time interval via said available network elements.

22. The method of claim 13, wherein said message is selected from the group consisting of SMS messages, WAP messages, e-mail, push advertising, streaming video and voice messages.
